(19) United States
(12) Patent Application Publication
(10) Pub. No.: US 2026/0287155 A1
(43) Pub. Date: Sep. 24, 2026

(54) OPTICAL INSPECTION SYSTEM FOR AUTOMATED DETECTION OF BIOLOGICAL CONTAMINANTS AND SURFACE DEFECTS IN FISH FILLETS COMBINED WITH SHADOW-FREE ILLUMINATION LAMP

(71) Applicant: Prospection Solutions, LLC, Kearney, MO (US)

(72) Inventors: Boris DEL VALLE, SR., Kearney, MO (US); Boris William DEL VALLE, JR., Kearney, MO (US)

(21) Appl. No.: 19/459,857

(22) Filed: Jan. 26, 2026

Related U.S. Application Data
(63) Continuation-in-part of application No. 19/340,046, filed on Sep. 25, 2025.
Application No. 19/340,046 is a continuation of application No. 19/074,810, filed on Mar. 10, 2025, now Pat. No. 12,449,112.

(51) Int. Cl. F21V 19/00; F21S 4/28; F21V 3/04; F21Y 115/10

(52) U.S. Cl. CPC F21V 19/0045; F21S 4/28; F21V 3/049; F21Y 2115/10

(57) ABSTRACT

Three conveyors with inter-conveyor gaps, ultraviolet and visible light inspection stations above and below, and a control unit with a virtual encoder to coordinate conveyor operation, synchronize image capture, and enable comprehensive inspection of both sides of food-stuff in transit.

### CROSS-REFERENCE TO RELATED APPLICATIONS

This present application is a continuation-in-part of Ser. No. 19/340,046 filed Sep. 25, 2025 which is a continuation of U.S. patent application Ser. No. 19/074,810 filed Mar. 10, 2025 the contents of which are hereby incorporated by reference herein.

### TECHNICAL FIELD

This disclosure relates to automated optical inspection systems for the food processing industry, and more specifically, to dual-mode, dual-sided inspection systems incorporating shadow-free illumination arrangements for detecting biological contaminants and surface defects in food products, such as fish fillets, using ultraviolet and visible light sources positioned to enhance illumination uniformity and reduce shadow artifacts in machine vision applications.

### BACKGROUND INFORMATION

Effective illumination is crucial in a wide range of applications, from workspaces and surgical environments to food inspection. Traditional lighting designs typically employ either a continuous light source or an array of discrete light sources arranged in linear or circular patterns. However, these configurations often result in pronounced shadows and uneven illumination due to the directional nature of light emission.

One known approach to improving shadow reduction involves the use of light shades or diffusers with a periodic or wavy edge to scatter light and reduce harsh shadow formation. A wavy edge design, wherein the shade features an undulating contour, disrupts the uniform shadow boundary and introduces a gradual transition between illuminated and shadowed regions. This effect is achieved by modifying the occlusion geometry of the shade, allowing more light to be scattered into previously shadowed areas. As a result, this technique has been employed to mitigate the formation of sharp shadows.

While light-shade-based solutions offer some advantages in shadow diffusion, they also introduce several drawbacks.

Loss of Light Intensity: The use of an obstructing shade inherently blocks a portion of emitted light, leading to reduced overall illumination efficiency.

Glare and Light Spill Issues: Depending on the shape of the wavy edge, undesired refractions and reflections may cause glare or non-uniform light dispersion in unintended areas.

Limited Flexibility: Fixed light-shade geometries provide only a static modification of light distribution, making them less adaptable to varying illumination requirements.

Complex Manufacturing and Aesthetic Considerations: Incorporating periodic or sinusoidal patterns into rigid light shades can complicate manufacturing and design processes, particularly when integrating them into consumer lighting fixtures.

In addition to the challenges associated with general illumination systems, the inspection of food products, such as fish fillets, for biological contaminants presents unique difficulties in prior art systems. Conventional inspection methods in the seafood processing industry often rely on manual human operators to visually detect parasites, such as nematodes, or other biological hazards through candling or surface examination under standard lighting. These approaches are labor-intensive, subjective, and prone to inconsistencies due to operator fatigue, varying skill levels, and environmental factors, leading to detection rates that may miss up to 30-50% of contaminants in high-volume production lines.

Automated prior art systems attempting to address these issues, such as single-sided optical imaging or X-ray-based detection, fall short in effectively identifying low-density biological contaminants like parasites. For instance, X-ray methods are ineffective for detecting non-dense organic materials that do not provide sufficient contrast, while visible light imaging alone fails to highlight fluorescence-emitting contaminants without specialized excitation. Moreover, these systems typically inspect only the top surface of the product, requiring manual flipping of fillets to examine the underside, which disrupts continuous processing, increases contamination risks, and reduces throughput to below 100 fillets per minute in many cases.

Ultraviolet (UV) illumination has been explored in limited prior art applications for fluorescence-based detection, where UV light at wavelengths around 365 nm excites biological contaminants to emit visible fluorescence. However, existing UV inspection setups suffer from several drawbacks, including non-uniform illumination leading to shadows and glare on irregular fish surfaces, lack of dual-sided (top and bottom) coverage without product manipulation, and absence of synchronization with conveyor systems for real-time, high-speed analysis. This results in false negatives, where contaminants on curved or textured areas are obscured, and false positives from ambient light interference, compromising food safety compliance and operational efficiency in industrial settings.

Furthermore, prior art UV systems often operate in isolation without integration into multi-mode inspection lines, limiting their ability to combine fluorescence detection with complementary visible light analysis for comprehensive defect identification. These limitations necessitate an improved system that incorporates shadow-free UV illumination in a dual-sided, synchronized configuration to enable automated, high-throughput detection of biological contaminants while maintaining product flow and minimizing human intervention.

Given these limitations, an improved lighting system is needed that achieves the benefits of a dual-mode inspection system comprising separate inspection stations: one incorporating ultraviolet (UV) emitters at approximately 365 nm for fluorescence-based detection of biological contaminants, and another incorporating visible light sources for surface defect analysis. The lighting system naturally softens shadows, enhances uniformity, and increases efficiency without the inherent drawbacks of external shading components, while the separate UV station enables targeted excitation of contaminants, collectively supporting comprehensive inspection in applications such as food processing.

### SUMMARY

The present invention provides an optical inspection system for food-stuff comprising a first conveyor, a second conveyor, and a third conveyor arranged in series along a travel path, wherein a discharge end of the first conveyor is spaced from a receiving end of the second conveyor to define a first inter-conveyor gap, and a discharge end of the second conveyor is spaced from a receiving end of the third conveyor to define a second inter-conveyor gap. A first bottom inspection station is positioned beneath the first inter-conveyor gap and oriented upward to view a bottom side of the food-stuff as the food-stuff traverses the first inter-conveyor gap, the first bottom inspection station comprising at least one ultraviolet illumination source and at least one image capture device. A second bottom inspection station is positioned beneath the second inter-conveyor gap and oriented upward to view the bottom side of the food-stuff as the food-stuff traverses the second inter-conveyor gap, the second bottom inspection station comprising at least one visible-spectrum illumination source and at least one image capture device. A first top inspection station is positioned above at least one of the first conveyor, the second conveyor, and the third conveyor and oriented downward to view a top side of the food-stuff while supported by the corresponding conveyor, the first top inspection station comprising at least one ultraviolet illumination source and at least one image capture device. A second top inspection station positioned above at least one of the first conveyor, the second conveyor, and the third conveyor and oriented downward to view the top side of the food-stuff while supported by the corresponding conveyor, the second top inspection station comprising at least one visible-spectrum illumination source and at least one image capture device. The first bottom inspection station and the second bottom inspection station are respectively positioned between the first and second conveyors and between the second and third conveyors to inspect the bottom side of the food-stuff while the food-stuff is unsupported over the respective inter-conveyor gap. The first top inspection station and the second top inspection station and the first and second bottom inspection stations collectively provide both ultraviolet inspection and visible light inspection of the food-stuff on both top and bottom sides.

In an embodiment, the optical inspection system further comprises a control unit configured to coordinate operation of the first, second, and third conveyors and to synchronize image capture by the top and bottom inspection stations. The control unit comprises a virtual encoder configured to generate position and speed information for food-stuff traveling along a product travel path without requiring a physical shaft encoder. The virtual encoder can estimate position and speed based at least in part on at least one of: (i) conveyor drive commands, (ii) motor current or torque feedback, (iii) conveyor motor speed feedback, (iv) timing of image frames acquired by the inspection stations, and (v) detection of food-stuff leading and trailing edges by at least one image capture device, wherein the control unit is configured to trigger image capture by at least one of the top or bottom inspection stations based on position information output by the virtual encoder. The control unit can be configured to adjust at least one illumination parameter selected from exposure duration, illumination intensity, strobe timing, and spectral channel selection in response to speed information from the virtual encoder. The control unit can also be configured to compensate for conveyor slippage by updating a scale factor applied to the virtual encoder output based on correlation between observed food-stuff features in successive images and expected displacement at the current conveyor speed. The control unit can also be configured to maintain independent virtual encoder state estimates for the first, second, and third conveyors and to account for acceleration or deceleration transitions of food-stuff across the first inter-conveyor gap and the second inter-conveyor gap. The control unit can also be configured to synchronize image acquisition of the first and second bottom inspection stations with traversal of the food-stuff over the first inter-conveyor gap and the second inter-conveyor gap, respectively, based on position information from the virtual encoder, wherein at least one inspection station comprises a line-scan camera, and the control unit is configured to set a line rate for the line-scan camera according to the conveyor speed indicated by the virtual encoder to achieve substantially square pixels. The control unit can also be configured to generate a composite representation of the food-stuff by combining images from at least one top inspection station and at least one bottom inspection station using position and speed information from the virtual encoder. The control unit can also be configured to predict a future position of a detected defect on the food-stuff along the product travel path and to actuate a rejector at a corresponding downstream location at a time determined from the virtual encoder.

In an embodiment, the at least one visible-spectrum illumination source of the second top inspection station can further comprise a base configured as a modular structure; a mounting surface supported by the base and arranged in an undulating pattern defined by alternating convex and concave deviations from a reference axis; and a plurality of visible light sources secured on the mounting surface, wherein the undulating pattern of the mounting surface scatters light from the light sources to reduce shadow formation and enhance illumination uniformity without external occluding elements.

In another embodiment, a method for dual-mode, dual-sided optical inspection of food-stuff is provided. The method comprises conveying the food-stuff along a travel path on a first conveyor, a second conveyor, and a third conveyor arranged in series; transferring the food-stuff from a discharge end of the first conveyor to a receiving end of the second conveyor across a first inter-conveyor gap and from a discharge end of the second conveyor to a receiving end of the third conveyor across a second inter-conveyor gap; imaging a bottom side of the food-stuff with a first bottom inspection station comprising at least one ultraviolet illumination source and at least one image capture device while the food-stuff is unsupported over the first inter-conveyor gap; imaging the bottom side of the food-stuff with a second bottom inspection station comprising at least one visible-spectrum illumination source and at least one image capture device while the food-stuff is unsupported over the second inter-conveyor gap; and imaging a top side of the food-stuff with a first top inspection station comprising at least one ultraviolet illumination source and at least one image capture device and with a second top inspection station comprising at least one visible-spectrum illumination source and at least one image capture device while the food-stuff is supported by at least one of the first conveyor, the second conveyor, and the third conveyor; wherein the first and second top inspection stations and the first and second bottom inspection stations collectively provide both ultraviolet inspection and visible light inspection of the food-stuff on both top and bottom sides.

In an embodiment, the method further comprises coordinating operation of the first, second, and third conveyors and synchronizing image capture by the top and bottom inspection stations using a control unit. In an embodiment, the method further comprises generating, by the control unit, position and speed information for food-stuff traveling along the travel path using a virtual encoder without requiring a physical shaft encoder. In an embodiment, generating the position and speed information comprises estimating based at least in part on at least one of: conveyor drive commands, motor current or torque feedback, conveyor motor speed feedback, timing of image frames acquired by the inspection stations, and detection of food-stuff leading and trailing edges by at least one image capture device. In an embodiment, the method further comprises triggering image capture by at least one of the top or bottom inspection stations based on position information output by the virtual encoder. In an embodiment, the method can further comprise adjusting at least one illumination parameter selected from exposure duration, illumination intensity, strobe timing, and spectral channel selection in response to speed information from the virtual encoder. In an embodiment, the method can further comprise synchronizing image acquisition of the first and second bottom inspection stations with traversal of the food-stuff over the first inter-conveyor gap and the second inter-conveyor gap, respectively, based on position information from the virtual encoder. In an embodiment, the method can further comprise generating a composite representation of the food-stuff by combining images from at least one top inspection station and at least one bottom inspection station using position and speed information.

### BRIEF DESCRIPTION OF THE DRAWINGS

These and other features and advantages of the present invention will be better understood by reading the following detailed description, taken together with the drawings wherein:

FIG. 1 is a perspective view of a lighting array on an undulating surface according to this disclosure.

FIG. 2 is a front facing view of the

FIG. 3 is a rear-facing view

FIG. 4 is perspective view of a lighting array on an undulating surface that is formed in a circle.

FIG. 5 is a perspective view of a lighting array on an undulating surface that is formed in a semi-circle.

FIG. 6 is an exploded view of a housing for the lighting array of FIG. 1.

FIG. 7 is a circuit diagram for operating the lighting array of FIG. 6.

FIG. 7-1 is a continuation of the circuit diagram of FIG. 7.

FIG. 8 illustrates an optical inspection system for automated detection of biological contaminants and surface defects in food products according to an embodiment of this disclosure.

FIG. 9 is a functional block diagram illustrating hardware components of the processor for processing a series of images from the cameras incorporated into the system of FIG. 8.

### DETAILED DESCRIPTION OF THE PREFERRED EMBODIMENTS

In accordance with one aspect of the present invention, a lamp 100 comprising of a base 102 supporting a mounting channel 104 configured to receive a light sources 106 is disclosed. Base 102 supports mounting channel 104 that is arranged in a periodic, undulating pattern to scatter light and reduce harsh shadow formation. The undulating pattern disrupts a uniform shadow boundary and introduces a gradual transition between illuminated and shadowed regions. This effect is achieved by modifying the geometry of the light dispersal, allowing more light to be scattered into more areas and to mitigate the formation of sharp shadows.

For the purposes of this disclosure, an undulating pattern refers to a non-periodic, periodic, or quasi-periodic spatial arrangement in which mounting channel 104 or elements, such as light sources 106, follow a path characterized by alternating convex and concave deviations from a reference axis. The reference axis can be any line on a surface of base 102, for example, the bottom surface of base 102 from which the structure extends. The pattern may be defined mathematically as non-periodic or periodic by sinusoidal functions, piecewise polynomial curves, spline-based paths, or other continuous or segmented waveforms. The undulations may exhibit uniform or non-uniform amplitude and wavelength, and may vary in shape, including but not limited to sinusoidal, triangular, sawtooth, parabolic, elliptical, or irregularly modulated contours. The undulating pattern may be defined in one-dimensional, two-dimensional, or three-dimensional spatial arrangements and may be dynamically adjustable.

Base 102 with mounting channel 104 are formed to support the undulating pattern. Base 102 serves as a support and mounting structure for lamp 100. Base 102, is configured to incorporate mounting channel 104 that follows the predefined undulating path, enabling precise placement of light sources 106 along a curved trajectory that enhances illumination uniformity and shadow reduction. The undulating pattern scatters light from the light sources 106 to reduce shadow formation and enhance illumination uniformity without external occluding elements, such as separate, passive components or structures positioned outside the primary light-emitting source or its immediate mounting arrangement, which are designed to block, redirect, or diffuse light to modify its distribution or reduce undesirable effects like shadows or glare (e.g., light shades, diffusers, reflectors, louvers or grilles, or baffles). Illumination uniformity refers to as a consistent distribution of light intensity across a target area where variations in brightness are minimized to ensure even lighting without significant gradients, hotspots, or dark patches.

Base 102 can be made as a solid structure or as a truss to reduce the amount of material and weight. Base 102 can fabricated using various materials and manufacturing techniques, including but not limited to:
3D Printing: Base 102 may be additively manufactured from thermoplastics such as polylactic acid (PLA), acrylonitrile butadiene styrene (ABS), polyethylene terephthalate glycol (PETG), polycarbonate (PC), or nylon, providing design flexibility and rapid prototyping capabilities.
Extrusion: For mass production, base 102 may be extruded from aluminum, stainless steel, or high-performance plastics, ensuring durability, heat dissipation, and structural stability.
Injection Molding: Base 102 may be formed from injection-molded polymers, such as polypropylene (PP), polyetherimide (PEI), or fiberglass-reinforced composites, for applications requiring high strength-to-weight ratios.
Machining: Base 102 can be CNC-machined from solid metal blocks or polymer sheets, providing precise geometric tolerances suitable for industrial and medical applications.

Base 102 is constructed as a modular, sectioned structure, enabling seamless extension to any desired length through snap-together connections. Each section of base 102 is designed with integrated interlocking features 108, such as male-female connectors 108a, 108b, dovetail joints, or snap-fit tabs, allowing multiple sections to be securely joined without the need for additional fasteners or adhesives. This modular configuration provides scalability and customization, making it adaptable for a wide range of lighting applications.

Each section of base 102, for example, can be fabricated with standardized interlocking features 108 at both ends, allowing multiple units to be linked in series to achieve a continuous lighting array. The snap-fit mechanism ensures: (i) Tool-free assembly and disassembly, facilitating quick installation and reconfiguration; (ii) Electrical continuity (if conductive pathways are included) for powering multiple interconnected light modules without requiring separate wiring; and (iii) Structural integrity, preventing misalignment or separation under operational conditions. This extendable design is particularly beneficial for applications where adjustable illumination coverage is required, such as machine vision systems or conveyor belt lighting.

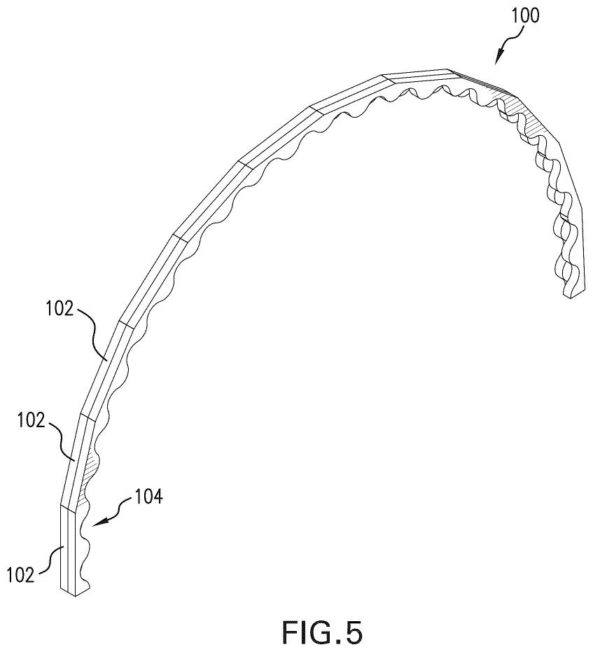

In addition to linear extensions, base 102 may be manufactured in pre-curved sections or flexible modular segments, enabling the formation of: (i) Circular lamps or ring lights, as shown in FIG. 4, ideal for 360-degree illumination in microscopy, surgical lighting, or machine vision inspection where uniform light distribution is essential; (ii) Custom-curved lighting shapes, allowing integration into non-linear architectural designs, automotive lighting, or ergonomic workstation lamps; and (iii) Elliptical, parabolic, or helical configurations, tailored for specific optical applications requiring directional light control. Each curved section of base 102 is designed with precisely engineered connection points, ensuring smooth transitions between segments without creating visible gaps or inconsistencies in light distribution.

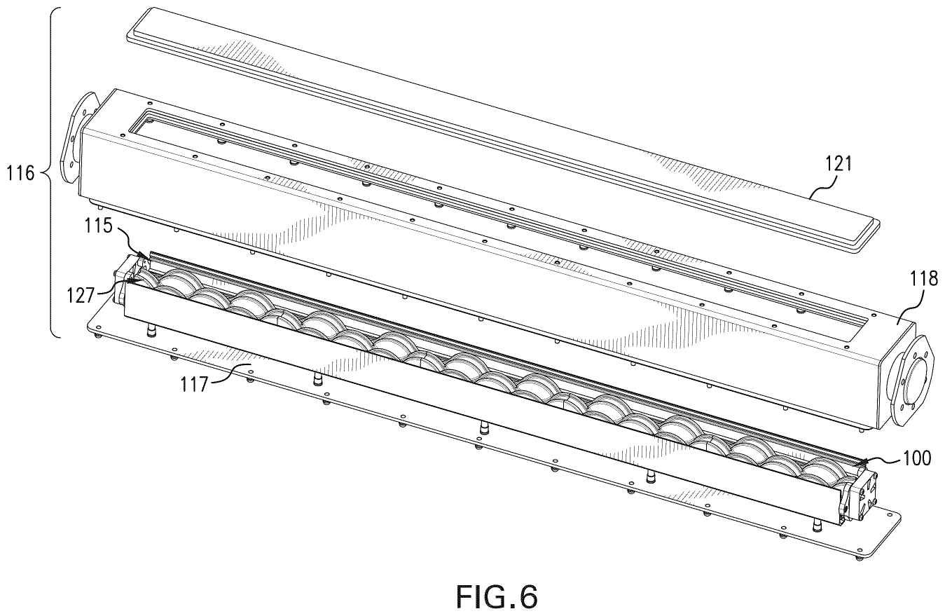

To accommodate complex lighting geometries, base 102 may include mix-and-match straight and curved sections, allowing users to: (i) Create semi-circular or arched lighting fixtures, as shown in FIG. 5, for wall-mounted or overhead installations; (ii) Combine convex and concave sections to direct light in a targeted, controlled manner; and (iii) Integrate adjustable hinge or pivot joints between segments for dynamically reconfigurable lighting arrays.

Base 102 may be manufactured from rigid materials (e.g., aluminum, steel, or reinforced thermoplastics) for fixed curved configurations. Base 102 can also be made from semi-flexible polymers (e.g., silicone-infused plastics or elastomer composites) to allow bendable or adaptive positioning without compromising durability. The scalability of base 102 enables customization of light coverage for different applications, ease of transport and storage, since modular sections can be disassembled for compact storage and transported efficiently. Base 102 can also be manufactured cost effectively, because curved and straight sections can be mass-produced separately and combined as needed for different lighting system configurations.

Base 102 can also be expanded laterally, side-to-side, to increase the width of the illumination field. Lateral expansion is facilitated by secondary interlocking features 109, such as male-female connectors 109a, dovetail joints, or snap-fit tabs integrated along the sides of each base 102. These features allow multiple units of base 102 to be connected in parallel, forming a wider lighting array. For example, two or more linear or curved sections of base 102 can be joined laterally to illuminate a broader workspace, such as a large inspection table or surgical field. The lateral interlocking features 109 can maintain alignment of the undulating mounting channels across sections or be offset from each other, as shown, ensuring consistent light distribution without gaps or overlaps. Base 102 can also be pre-formed with multiple laterally adjacent bases 102, as shown. Optionally, lateral expansion may include flexible bridge connectors to accommodate spaces between adjacent units. This could allow for the placement of a camera of a machine vision system to view through the space.

Mounting channel 104 is integrated on top of base 102 and follows a continuous, undulating path. In the illustrated embodiment, mounting channel 104 is opened at each end with inwardly oriented dovetails 112a, 112b on opposite sides of mounting surface 114 allowing for the insertion of light sources 106. Each base 102 with mounting channel 104 can serve as a connection point or splice bite for adjoining sections of light sources 106, which improved modularity and ease of replacement of damaged sections.

Mounting channel 104, however, can be open ended or closed ended with for insertion and securement of light sources. Mounting channel 104 dimensioned to accommodate different light modules, such as LED strips, fiber optic bundles, or laser diode arrays. Mounting channel 104 can also be equipped with fasteners or clips to facilitate easy installation, removal, and repositioning of light sources along the undulating path. Light sources 106 could also be secured to mounting surface 114 by glue or other form of adhesive.

Mounting channel 104 can be constructed from aluminum or thermally conductive plastics with base 102 functioning as a heat sink. Mounting channel 104 can be manufactured with ventilation channels to manage thermal output from high-intensity light sources.

Light sources 106 are configured to be inserted into mounting channel 104 and may include a broad array of illumination technologies, such as, but not limited to, light-emitting diodes (LEDs), organic LEDs (OLEDs), fiber optic strands, laser diode arrays, incandescent bulbs, fluorescent tubes, compact fluorescent lamps (CFLs), halogen lamps, high-intensity discharge (HID) lamps (e.g., metal halide, sodium vapor), electroluminescent (EL) panels or wires, plasma lamps, and quantum dot LEDs (QLEDs). In one embodiment, LEDs are arranged in a strip format, with dimensions such as ⅜″ wide, ⅛″ thick, and available in 16.4′ sections, featuring a 1-⅛″ spacing between each LED and a beam angle of 120 degrees, optimizing light overlap along the undulating path to minimize shadow formation. Other light sources, such as incandescent or halogen bulbs, may be mounted individually or in linear arrays with socketed bases compatible with mounting channel 104, providing high-lumen output for general illumination. Fluorescent tubes or CFLs, available in modular lengths (e.g., 2′ or 4′ sections), can be secured within the channel using clips or end-caps, offering energy-efficient, diffuse light suitable for large workspaces. Fiber optic strands may be bundled and routed through the channel, terminating in adjustable lenses or diffusers to direct light precisely, while laser diode arrays can emit collimated beams for high-precision tasks, such as machine vision or surgical applications. Light sources 106 may emit white light with adjustable color temperatures (e.g., 2700K to 6500K) for task adaptability, monochromatic light (e.g., red, green, blue) for aesthetic or functional purposes, or non-visible wavelengths, such as ultraviolet (UV) for sterilization, fluorescence excitation, or curing processes, and infrared (IR) for thermal imaging or night vision support. With a laterally expanded base 102, as described above, each adjacent mounting channel 104 could be configured with light sources of differing wavelengths-for instance, a UV-emitting source alongside a visible-light source to delineate a boundary for non-visible illumination, enhancing safety or operational clarity in mixed-use environments. Electroluminescent panels or wires, being thin and flexible, can conform to the undulating path for uniform, low-profile lighting, while HID lamps or plasma sources, with their intense output, may suit industrial settings requiring broad-area illumination. The benefit of using strip lighting (e.g., LED or fluorescent strips) or other modular formats for light source 106 lies in their scalability, ease of replacement, and compatibility with commercial off-the-shelf (COTS) components, enabling cost-effective customization to fit any configuration of base 102 and mounting channel 104. Additionally, hybrid configurations-such as combining OLEDs for soft, diffuse light with laser diodes for focused beams-can be implemented within a single channel or across adjacent channels, leveraging the modular design to meet diverse illumination needs.

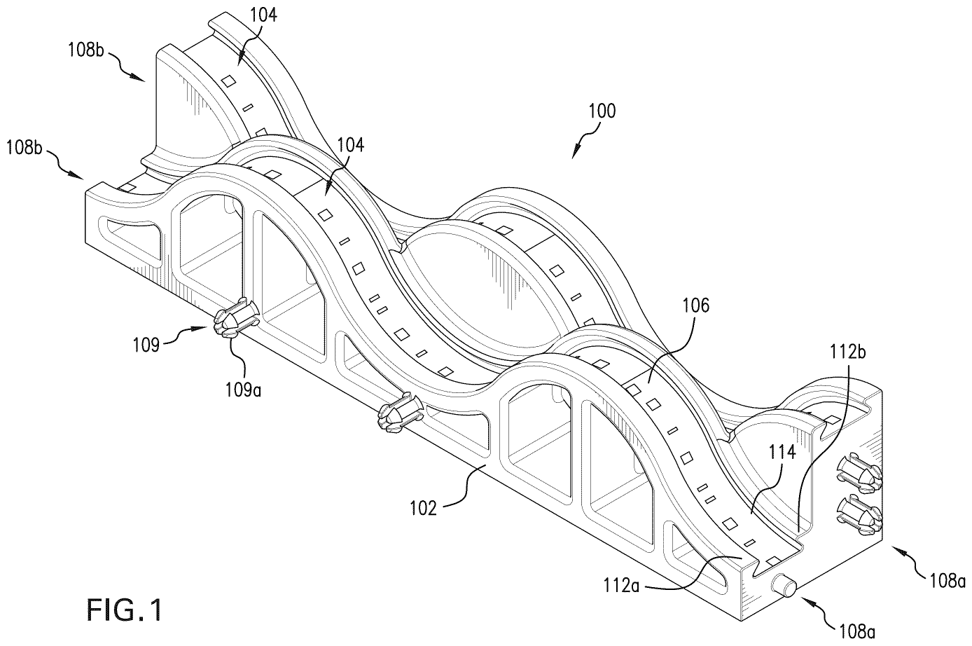

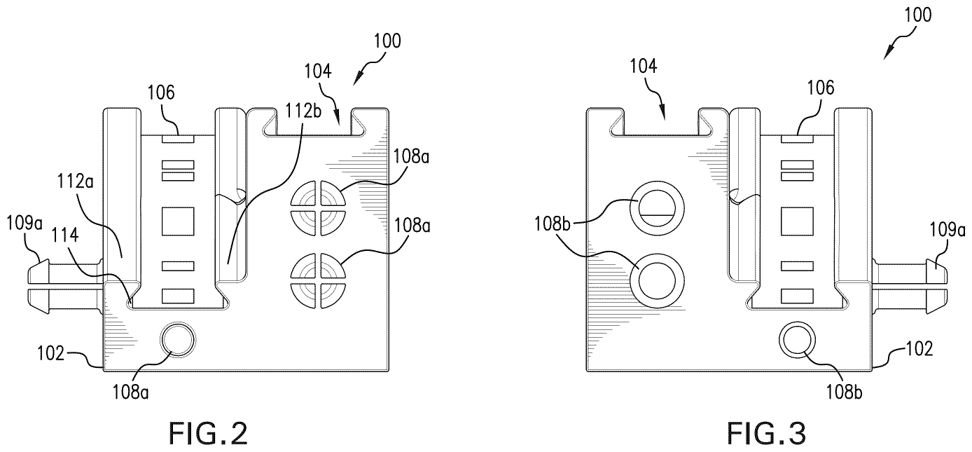

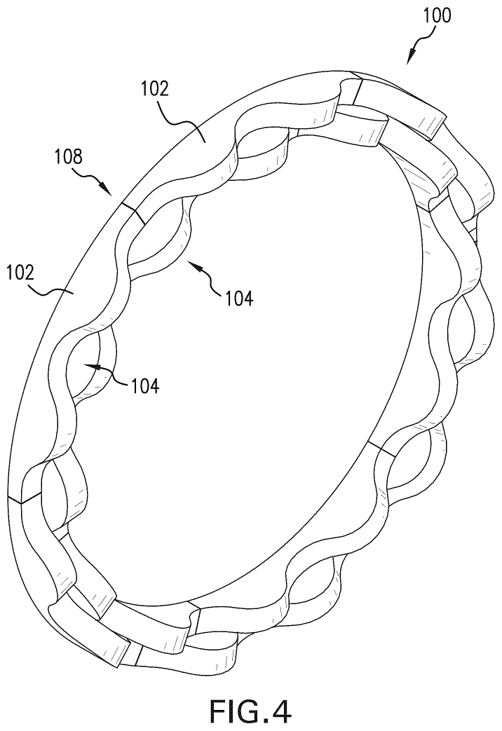

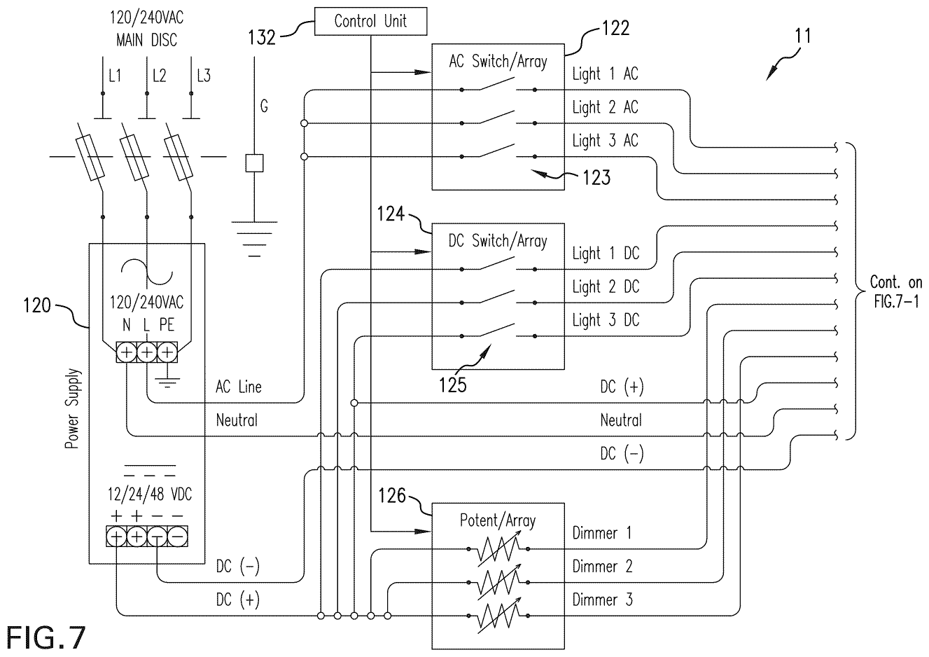

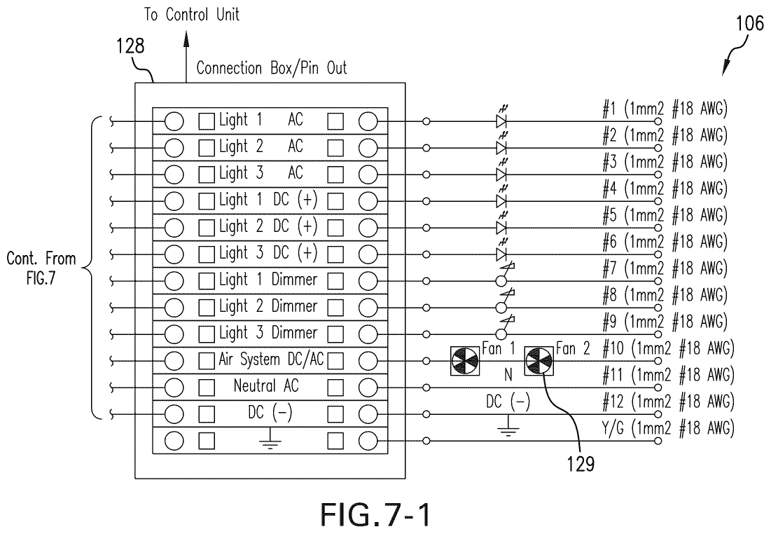

FIG. 6 illustrates an exploded view of housing assembly 116 for lamp 100, which integrates base 102 and an array of light sources 106. Housing assembly 116 comprises housing 118, a receptacle 115 configured to securely receive base 102 via a snap-fit or alternative attachment mechanism (e.g., threaded fasteners, magnetic couplings, or slide-and-lock rails), and a top cover 117 that conceals and protects wiring and control circuitry for light sources 106 while remaining accessible for maintenance. Housing 118, serving as a robust outer shell, may be constructed from durable, corrosion-resistant materials such as stainless steel, aluminum, high-strength polymers (e.g., polycarbonate, ABS), or reinforced composites, tailored to withstand environmental stresses like chemical exposure, temperature extremes, or mechanical impact. A transparent or translucent shield 121—made from materials such as plexiglass, tempered glass, acrylic, or optical-grade polycarbonate—covers the bottom of housing 118, permitting light transmission while preventing ingress of water, dust, debris, or other contaminants, with sealing options (e.g., gaskets, O-rings, or silicone) to achieve ingress protection ratings (e.g., IP65, IP67) suitable for wet or dusty conditions. To manage thermal output from light sources 106 and associated electronics, housing 118 incorporates ventilation features such as air channels 127, louvers, or perforations for passive heat exchange, with optional active cooling provided by fans 129 (see FIG. 7-1), blowers, or liquid cooling conduits mounted within or atop the assembly. Designed for versatility, housing assembly 116 is fully sealable with smooth, non-porous surfaces and optional antimicrobial coatings, meeting stringent hygiene and safety standards (e.g., NSF, FDA, USDA) for sensitive environments like food processing, meat packing, pharmaceutical production, or cleanrooms, as well as hazardous settings (e.g., explosive atmospheres or chemical plants) with flame-retardant reinforcements. Optional mounting accessories, such as brackets, pole adapters, or suspension hooks, enable installation on walls, ceilings, floors, or portable stands, ensuring adaptability across residential, commercial, industrial, or field applications. This comprehensive design ensures housing assembly 116 protects lamp 100 while optimizing functionality, durability, and compliance in diverse operating conditions, from sterile laboratories to rugged outdoor worksites.

FIG. 7 shows the electrical schematic for controlling light sources 106. In an embodiment, a power distribution and control system 119 for LED lighting and fans is provided. A universal power supply 120 receives three-phase AC input (e.g., 122V/240V) and generates separate AC and DC outputs. Universal power supply 120 can an AC switch array 122, a DC switch array 124, and a potentiometer array 126 for dimming, all of which connect to a distribution box that supplies power to array of light sources 106 and ventilation fans 129. More specifically, universal power supply 120 can receive a single or three-phase 120V/240V AC input and converts it into two distinct outputs: a two-line AC output and a regulated DC voltage output. The AC output is directed to AC switch array 122 comprising multiple switches 123, each corresponding to an individual AC-powered light sources 106. This configuration allows independent ON/OFF control of each AC powered light source 106. The DC output is split into two branches: a DC switch array 124 and a potentiometer array 126. DC switch array 124 comprises of multiple switches 125 corresponding to individual DC-powered light sources 106, enabling selective activation. Potentiometer array 126 is wired in parallel with DC switch array 124, allowing for adjustable voltage or current control, thereby enabling dimming functionality for the DC-powered light sources 106. All or any combination of AC switch array 122, a DC switch array 124, and a potentiometer array 126 can be used. A connection box 128 serves as the final distribution hub, receiving one or both AC and DC power lines from their respective switch AC switch array 122, DC switch array 124, and potentiometer array 126, and routing them to the appropriate fixtures for light sources 106. AC-powered LEDs, for example, operate in a straightforward ON/OFF manner, while DC-powered LEDs, for example, benefit from dimming control via potentiometer array 126. System 119 also includes fans 129 directly connected to the DC output to maintain continuous airflow and cooling.

Optional features include surge protection, power factor correction, and emergency battery backup within universal power supply 120, ensuring reliability in unstable or critical environments (e.g., outdoor worksites, medical facilities). All components of system 119 can be selectively combined—using AC switch array 122 alone for simple setups, or integrating DC switch array 124 and potentiometer array 126 for advanced control—offering scalability and adaptability to the invention's modular design.

A control unit 132 may be integrated into system 119 to provide dynamic, programmable management of light sources 106 and auxiliary components, enhancing the functionality of system 119 across diverse applications such as workspaces, food inspection, surgical lighting, or machine vision systems. Control unit 132 interfaces with AC switch array 122, DC switch array 124, and potentiometer array 126 via a microcontroller or programmable logic controller (PLC), enabling real-time adjustments to light intensity, color temperature, wavelength selection (e.g., toggling between UV and visible light), or activation patterns (e.g., pulsing for stroboscopic effects, sequential activation for conveyor tracking). Communication with control unit 132 can occur through wired protocols (e.g., DMX512, Modbus, Ethernet) or wireless protocols (e.g., Bluetooth, Zigbee, Wi-Fi, LoRa), allowing remote operation or integration with smart building systems. For example, in a laterally expanded base 102 with multiple mounting channels 104, control unit 132 can independently adjust adjacent sections—dimming visible LEDs in one channel while pulsing IR LEDs in another—to create boundary zones or task-specific illumination profiles. Advanced features may include sensors (e.g., ambient light sensors, temperature sensors, occupancy detectors) mounted within housing assembly 116, feeding data to control unit 132 for automated responses, such as increasing fan speed under high thermal loads or reducing brightness in low-traffic areas. Control unit 132 may also support pre-programmed modes tailored to the undulating pattern's shadow-reduction capabilities—e.g., a ‘soft glow’ mode with uniform dimming across all sources, or a ‘high-contrast’ mode emphasizing alternating source activation. In sensitive environments (e.g., food processing, cleanrooms), control unit 132 can incorporate diagnostic capabilities, monitoring power draw or component health to ensure compliance with safety standards (e.g., NSF, FDA). For rugged or portable applications, control unit 132 may be housed in a sealed, shock-resistant module within housing 118, with an optional touchscreen or button interface for manual overrides. This enhanced control system complements the invention's modularity and environmental adaptability, enabling precise customization of light output to optimize uniformity, reduce shadows, and meet the demands of any operational context.

### UV INSPECTION SYSTEM

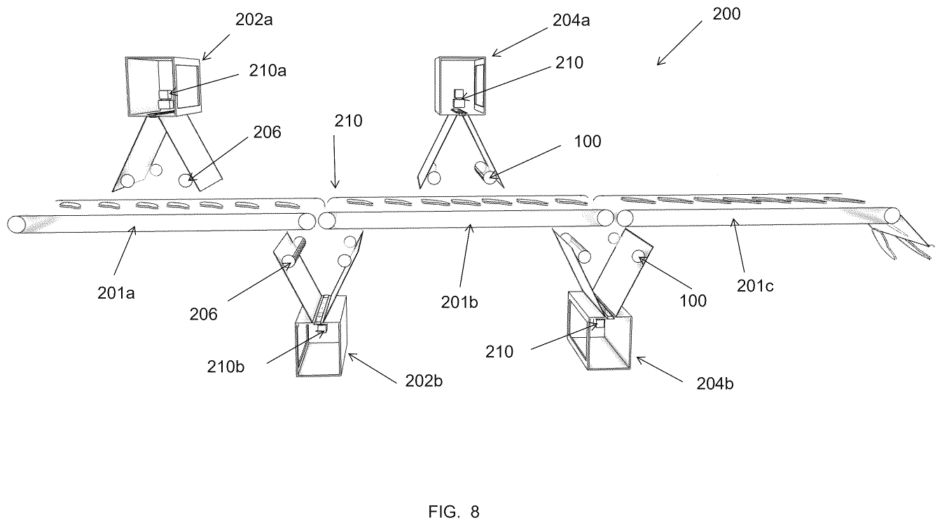

The lighting apparatus can be integrated into a dual-mode, dual-sided optical inspection system 200 (as shown in FIG. 8) for automated detection of biological contaminants and surface defects in food products, such as fish fillets. System 200 can comprise separate inspection stations arranged sequentially along a conveyor line: a first ultraviolet (UV) inspection station 202a for fluorescence-based detection of biological contaminants, such as parasites, on the top-side and a second UV inspection station 202b for fluorescence-based detection of biological contaminants, such as parasites, on the bottom-side. A first visible light inspection station 204a incorporating the shadow-free illumination lamp 100 described herein for surface defect detection on the top side and a second visible light inspection station 204b incorporating the shadow-free illumination lamp 100 on the bottom side. First UV inspection station 202a and second UV inspection stations 202b operate independently but in synchronization with a software-implemented virtual encoder 400 with the overall system 200 to enable continuous, high-throughput processing without manual intervention.

The UV inspection process begins as food products, such as fish fillets, enter the UV inspection station 200 via a first conveyor 202a. The first conveyor 202a transports the products at industrial speeds, typically up to 80 meters per minute (300 filets per minute), positioning them for illumination and imaging. Top and bottom UV LED modules 204, emitting light at approximately 365 nm, are positioned at 45° angles relative to the conveyor belt and approximately 4 inches from the belt surface to provide uniform excitation while minimizing shadowing on irregular surfaces.

First UV inspection station 202a and second UV inspection stations 202b can be aligned along a plane and oriented towards each other for simultaneous inspection of food stuff while it traverses gap 212, or can be positioned apart from each other, as illustrated. As the product passes through the UV inspection station 202a, virtual encoder 400 provides real-time positional feedback to synchronize activation of the UV LED modules 206 and image acquisition by line-scan cameras 210. The line-scan cameras 210 are mounted above (top camera 210a) and below (bottom camera 210b) the product path at a focal distance of approximately 21 inches, capturing high-resolution images of both the top and bottom surfaces. A 1.5-inch gap 212 between the first conveyor 202a and a subsequent conveyor 202b allows a bottom camera 210b to image the underside without requiring product flipping, ensuring dual-sided coverage.

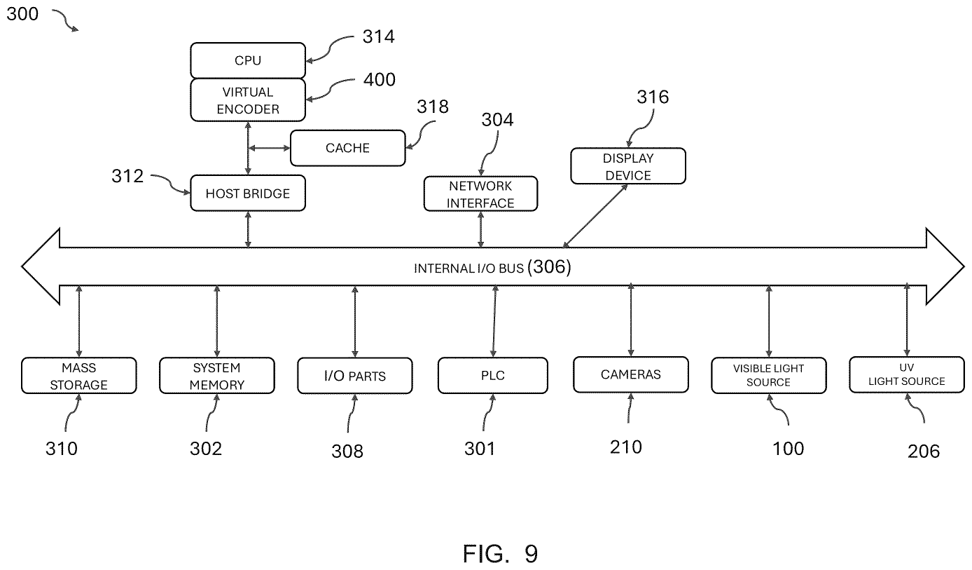

The 365 nm UV wavelength excites fluorescence in biological contaminants, causing them to emit visible light that contrasts against the non-fluorescent product tissue. The captured images are processed in real-time by vision software integrated with a control unit 300, shown in FIG. 9, which analyzes pixel intensity and contrast variations to detect fluorescence anomalies. Additional line scan cameras 201 are provided in visible light inspection stations 204 that work in cooperation with visible light sources 100 to provide a visual inspection of food stuff as it travels down the conveyor line.

The line-scan cameras 210 are high-resolution imaging devices configured to capture sequential lines of image data as the food products traverse the inspection stations 202, 204 on the conveyors 201. Each camera 210 comprises a linear array of photosensitive elements, such as charge-coupled device (CCD) or complementary metal-oxide-semiconductor (CMOS) sensors, that scan a single line perpendicular to the direction of product movement, building a two-dimensional image through synchronization with the conveyor speed via the virtual encoder. The cameras 210 are positioned at a focal distance of approximately 21 inches from the product surface to ensure optimal focus and field of view coverage, capturing high-resolution images at rates compatible with the system throughput of up to 300 fillets per minute. In the UV inspection stations 202a, 202b, cameras 210 detect visible fluorescence emissions from biological contaminants excited by the 365 nm UV illumination, while in visible light inspection stations 204a, 204b, they capture reflected light from the shadow-free white light illumination to identify surface defects and texture irregularities.

The same types of cameras may be used for both UV inspection stations 202 and visible light inspection stations 204, as both modes involve capturing light in the visible spectrum: fluorescence emissions in the UV stations fall within visible wavelengths, and reflected light in the visible stations is inherently visible. Accordingly, the same line-scan camera models, selected for their sensitivity to visible light (approximately 400-700 nm), high dynamic range, and low noise characteristics, may be employed across all stations to simplify system design, maintenance, and calibration. However, in alternative embodiments, cameras with enhanced near-UV sensitivity or optical filters (e.g., bandpass filters to isolate fluorescence wavelengths) may be used in the UV stations if needed to optimize contrast for specific contaminants, while standard visible-spectrum cameras suffice for the visible stations.

The term “line-scan cameras” as used herein encompasses all types of cameras suitable for the purposes described, including but not limited to monochrome or color CCD/CMOS line-scan cameras, hyperspectral line-scan cameras capable of multi-wavelength analysis, time-delay integration (TDI) line-scan cameras for improved signal-to-noise ratio in low-light conditions, and any other imaging devices that provide high-speed, high-resolution line-by-line scanning compatible with continuous conveyor-based inspection processes. This broad interpretation ensures flexibility in implementation, allowing adaptation to various food products or environmental conditions while maintaining the core functionality of dual-mode, dual-sided detection.

Control unit 300 can provide dynamic, programmable management of the light sources, cameras, virtual encoder 400, vision software, and auxiliary components, such as the pneumatic rejection mechanism, enhancing the functionality of system 200 across diverse applications such as food inspection or machine vision systems. Control unit 300 interfaces with the power distribution system, switches, and potentiometers, enabling real-time adjustments to light intensity, color temperature, wavelength selection (e.g., toggling between UV and visible light), or activation patterns (e.g., pulsing for stroboscopic effects, sequential activation for conveyor tracking). Communication with control unit 300 can occur through wired protocols (e.g., DMX512, Modbus, Ethernet) or wireless protocols (e.g., Bluetooth, Zigbee, Wi-Fi, LoRa), allowing remote operation or integration with other systems. For example, in a laterally expanded configuration with multiple mounting surfaces, control unit 300 can independently adjust adjacent sections-dimming visible LEDs in one section while pulsing UV LEDs in another-to create boundary zones or task-specific illumination profiles.

Control unit 300 is housed in an exemplary computing platform for executing the processing functions necessary to derive, calculate, and perform the functions described herein, including synchronization of illumination, image acquisition, vision processing, and rejection commands. In one implementation, control unit 300 can be implemented as a microcontroller. Control unit can be configured to adjust at least one illumination parameter selected from exposure duration, illumination intensity, strobe timing, and spectral channel selection in response to speed information from the virtual encoder. Control unit 300 can comprise a system memory 302, network interface 304, and one or more software applications and drivers enabling or implementing the methods and functions described herein. The hardware system includes a standard I/O bus 306 with I/O ports 308 and mass storage 310 (which can also be a non-volatile Flash Memory) coupled thereto or external or cloud-based storage, such as the Google or Amazon cloud services. Bridge 312 couples processors 314 to I/O bus 306. The hardware system may further include video memory and display device 316 coupled to the video memory. These elements are intended to represent a broad category of computer hardware systems, including but not limited to general-purpose computer systems based on the Pentium processor manufactured by Intel Corporation of Santa Clara, Calif., as well as any other suitable processor, including a graphics processing unit (“GPU”).

Elements of the computer hardware system perform their conventional functions known in the art. In particular, network interface 304 is used to provide communication between processors 314 and Ethernet networks (or any other network or external device). Mass storage 310 can be provided and used to provide permanent storage for the data and programming instructions to perform the above-described functions implementing the inspection processes, whereas system memory 302 (e.g., DRAM) is used to provide temporary storage for the data and programming instructions when executed by processors 314. I/O ports 308 are one or more serial and/or parallel communication ports used to provide communication between additional peripheral devices, such as the top and bottom line-scan cameras 210, UV LED modules 206, visible light sources 100, and a pneumatic rejection mechanism (peripheral 211).

Control unit 300 may include a variety of system architectures, and various components of processors 314 may be rearranged. For example, cache 318 may be on-chip with processors 314. Alternatively, cache 318 and processors 314 may be packed together as a “processor module,” with processors 314 being referred to as the “processor core.” Furthermore, certain implementations of the claimed embodiments may not require nor include all the above components. Also, additional components may be included, such as additional processors, storage devices, or memories.

Defect coordinates are mapped using data from a virtual encoder, generating a partial inspection map that is fused with results from the subsequent visible light station. Upon detection of contaminants, system 200 generates a rejection command, tracking the defective product via the virtual encoder to a downstream to a pneumatic rejection mechanism connected to control unit 300 as another peripheral 211, such as an air-actuated gate, which ejects the product within approximately 100 milliseconds. Non-defective products proceed uninterrupted to the visible light inspection station for complementary analysis. All components of the UV inspection station 202, including the UV LED modules 206 and line-scan cameras 210, are modular, fabricated from stainless steel, and rated for washdown environments in food processing facilities.

The UV inspection station 202 may include adjustable parameters controllable via a human-machine interface (HMI) 216, such as lighting intensity for calibration to different product types (e.g., Pollock, Cod, Halibut, or Black Cod) or environmental conditions. This configuration addresses prior art limitations by providing automated, dual-sided fluorescence detection, reducing labor by up to 70% and enhancing food safety compliance without disrupting product flow.

### VIRTUAL ENCODER

Inspection system 200 incorporates a virtual encoder 400 implemented in software within control unit 300 to derive spatial positioning information solely from real-time conveyor speed data provided by control unit 300 controlling the conveyor motors as peripherals 211. Unlike traditional systems that rely on physical rotary encoders mechanically coupled to conveyors 201, optical position sensors, or wheel-based measurement devices, the virtual encoder eliminates the need for any physical position-sensing hardware, thereby reducing mechanical complexity, potential for slip, wear, and alignment issues, while improving long-term reliability. Control unit 300 can be configured to maintain independent virtual encoder state estimates for the first, second, and third conveyors 201a, 201b, 201c and to account for acceleration or deceleration transitions of food-stuff across the first inter-conveyor gap 210 and the second inter-conveyor gap 210. This allows control unit 300 to be configured to synchronize image acquisition of the first and second bottom inspection stations 202b and 204b with traversal of the food-stuff over the first inter-conveyor gap 210 and the second inter-conveyor gap 210, respectively, based on position information from the virtual encoder 400.

A programmable logic controller (PLC) 301 maintains authoritative control over the motors controlling the belt velocity of conveyors 201, which velocity is defined by operator input or pre-programmed production recipes and continuously published to the inspection software via a communication interface. PLC 301 can provide to control unit 300 real-time conveyor speed updates to generate virtual encoder events and trigger pulses. Control unit 300 acquires these deterministic, real-time speed updates and computes spatial increments to generate with virtual encoder 400 synthetic virtual encoder pulses proportional to actual physical belt movement. For a configured spatial resolution, such as 0.5 mm per frame, control unit 300 calculates the required trigger frequency as trigger_frequency=conveyor_speed/distance_per_frame, producing a stream of virtual trigger pulses 404 that simulate encoder-equivalent positional accuracy. As such, virtual encoder estimates position and speed based at least in part on at least one of: (i) conveyor drive commands, (ii) motor current or torque feedback, (iii) conveyor motor speed feedback, (iv) timing of image frames acquired by the inspection stations, and (v) detection of food-stuff leading and trailing edges by at least one image capture device.

These virtual encoder pulses serve to synchronize image capture across the top and bottom line-scan cameras 210 210 in both the UV inspection stations 202a, 202b and visible light inspection stations 204a, 204b, ensuring that captures occur at precise, evenly spaced physical locations independent of belt acceleration, deceleration, or variations. Each frame captured by line-scan cameras 210 is tagged with a corresponding virtual encoder position index, enabling positional alignment without requiring physical coupling between cameras 210. The virtual encoder generates trigger pulses that are output/forwarded to cameras 210 as the trigger signal (hardware or logical trigger input depending on camera interface). Cameras 210 acquire image lines/frames in response to these trigger pulses.

Virtual encoder 400 supports configurable software-defined functions, including: (i) virtual delay, wherein virtual encoder events are offset by a distance-based parameter to align detection with downstream processes; (ii) trigger sensitivity logic, applying software thresholds and stability conditions to filter triggers during transient speed changes; and (iii) trigger repetitions, allowing each position event to generate multiple pulses for burst triggering, redundant sampling, or multi-event processing at a single conveyor position. Virtual delay, for example, is a software-adjustable offset in spatial units (mm). Control unit converts it to an equivalent time/trigger offset using conveyor speed, for example: delay_time=delay_distance/conveyor_speed. This virtual delay is used to synchronize camera triggers and/or downstream actuation with the product's physical travel distance. These and other features are adjustable per production recipe via the interface to control unit 300.

Frame synchronization in system 200 is achieved through a frame synchronization module 404 that correlates UV and RGB frames based on their shared virtual encoder indices, rather than through pixel-level overlay or geometric registration. Each camera 210 in inspection system 200 operates independently and performs its own image acquisition and inspection processing. Virtual encoder 400 does not force simultaneous image capture or pixel-level alignment between cameras 210. Instead, virtual encoder 400 provides a common spatial reference for the inspection system. Inspection results generated by each camera are tagged with a virtual encoder position or product index derived from conveyor movement. This allows inspection results from different cameras (for example, UV inspection and RGB inspection) to be associated at the product or positional level, ensuring that independent inspection outcomes correspond to the same physical item on the conveyor. No pixel-level overlay, geometric registration, or frame-by-frame synchronization is required. Each inspection stream remains independent, and correlation occurs only at the logical or decision level.

UV cameras 210 in stations 202a, 202b capture fluorescence emissions, while the RGB cameras 210 in stations 204a, 204b capture reflected visible light, with each stream remaining independent at the image level. This positional correlation ensures that frames from both spectral domains correspond to the same physical product or conveyor position.

Multi-spectral fusion occurs at the logical and decision level within the inspection processor in control unit 300. Independent inspection results from the UV (e.g., contaminant detection via fluorescence) and RGB (e.g., surface defect detection) analyses are combined to generate a unified outcome for product acceptance or rejection, transmitted to the pneumatic rejection mechanism, peripheral 211. Control unit 300 can be configured to generate a composite representation of the food-stuff by combining images from at least one top inspection station 202a, 204a and at least one bottom inspection station 202b, 204b using position and speed information from the virtual encoder. This approach permits optimization of imaging parameters for each mode while maintaining reliable correlation via virtual encoder 402, without the need for image fusion techniques that could introduce artifacts or computational overhead.

Alternatively, inspection system 200 can support an image-based motion/contrast trigger mode that detects movement/contrast changes against a stable background to gate/enable triggering or as a fallback mode when PLC speed input is unavailable.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

1-18. (canceled)

19. An optical inspection system for food-stuff comprising:
a first conveyor, a second conveyor, and a third conveyor arranged in series along a travel path, wherein a discharge end of the first conveyor is spaced from a receiving end of the second conveyor to define a first inter-conveyor gap, and a discharge end of the second conveyor is spaced from a receiving end of the third conveyor to define a second inter-conveyor gap;
a first bottom inspection station positioned beneath the first inter-conveyor gap and oriented upward to view a bottom side of the food-stuff as the food-stuff traverses the first inter-conveyor gap, the first bottom inspection station comprising at least one ultraviolet illumination source and at least one image capture device;
a second bottom inspection station positioned beneath the second inter-conveyor gap and oriented upward to view the bottom side of the food-stuff as the food-stuff traverses the second inter-conveyor gap, the second bottom inspection station comprising at least one visible-spectrum illumination source and at least one image capture device;
a first top inspection station positioned above at least one of the first conveyor, the second conveyor, and the third conveyor and oriented downward to view a top side of the food-stuff while supported by the corresponding conveyor, the first top inspection station comprising at least one ultraviolet illumination source and at least one image capture device; and
a second top inspection station positioned above at least one of the first conveyor, the second conveyor, and the third conveyor and oriented downward to view the top side of the food-stuff while supported by the corresponding conveyor, the second top inspection station comprising at least one visible-spectrum illumination source and at least one image capture device;
wherein the first bottom inspection station and the second bottom inspection station are respectively positioned between the first and second conveyors and between the second and third conveyors to inspect the bottom side of the food-stuff while the food-stuff is unsupported over the respective inter-conveyor gap, and wherein the first top inspection station and the second top inspection station and the first and second bottom inspection stations collectively provide both ultraviolet inspection and visible light inspection of the food-stuff on both top and bottom sides.

20. The optical inspection system of claim 19, and further comprising: a control unit configured to coordinate operation of the first, second, and third conveyors and to synchronize image capture by the top and bottom inspection stations.

21. The optical inspection system of claim 20, wherein the control unit comprises a virtual encoder configured to generate position and speed information for food-stuff traveling along a product travel path without requiring a physical shaft encoder.

22. The optical inspection system of claim 21, wherein the virtual encoder estimates position and speed based at least in part on at least one of: (i) conveyor drive commands, (ii) motor current or torque feedback, (iii) conveyor motor speed feedback, (iv) timing of image frames acquired by the inspection stations, and (v) detection of food-stuff leading and trailing edges by at least one image capture device.

23. The optical inspection system of claim 21, wherein the control unit is configured to trigger image capture by at least one of the top or bottom inspection stations based on position information output by the virtual encoder.

24. The optical inspection system of claim 21, wherein the control unit is configured to adjust at least one illumination parameter selected from exposure duration, illumination intensity, strobe timing, and spectral channel selection in response to speed information from the virtual encoder.

25. The system of claim 21, wherein the control unit is configured to compensate for conveyor slippage by updating a scale factor applied to the virtual encoder output based on correlation between observed food-stuff features in successive images and expected displacement at the current conveyor speed.

26. The optical inspection system of claim 21, wherein the control unit is configured to maintain independent virtual encoder state estimates for the first, second, and third conveyors and to account for acceleration or deceleration transitions of food-stuff across the first inter-conveyor gap and the second inter-conveyor gap.

27. The optical inspection system of claim 21, wherein the control unit is configured to synchronize image acquisition of the first and second bottom inspection stations with traversal of the food-stuff over the first inter-conveyor gap and the second inter-conveyor gap, respectively, based on position information from the virtual encoder.

28. The optical inspection system of claim 21, wherein at least one inspection station comprises a line-scan camera, and the control unit is configured to set a line rate for the line-scan camera according to the conveyor speed indicated by the virtual encoder to achieve substantially square pixels.

29. The optical inspection system of claim 21, wherein the control unit is configured to generate a composite representation of the food-stuff by combining images from at least one top inspection station and at least one bottom inspection station using position and speed information from the virtual encoder.

30. The optical inspection system of claim 21, wherein the control unit is configured to predict a future position of a detected defect on the food-stuff along the product travel path and to actuate a rejector at a corresponding downstream location at a time determined from the virtual encoder.

31. The optical inspection system of claim 19, wherein the at least one visible-spectrum illumination source of the second top inspection station further comprises:
a base configured as a modular structure;
a mounting surface supported by the base and arranged in an undulating pattern defined by alternating convex and concave deviations from a reference axis; and
a plurality of visible light sources secured on the mounting surface, wherein the undulating pattern of the mounting surface scatters light from the light sources to reduce shadow formation and enhance illumination uniformity without external occluding elements.

32. A method for dual-mode, dual-sided optical inspection of food-stuff, comprising:
conveying the food-stuff along a travel path on a first conveyor, a second conveyor, and a third conveyor arranged in series; transferring the food-stuff from a discharge end of the first conveyor to a receiving end of the second conveyor across a first inter-conveyor gap and from a discharge end of the second conveyor to a receiving end of the third conveyor across a second inter-conveyor gap;
imaging a bottom side of the food-stuff with a first bottom inspection station comprising at least one ultraviolet illumination source and at least one image capture device while the food-stuff is unsupported over the first inter-conveyor gap;
imaging the bottom side of the food-stuff with a second bottom inspection station comprising at least one visible-spectrum illumination source and at least one image capture device while the food-stuff is unsupported over the second inter-conveyor gap; and
imaging a top side of the food-stuff with a first top inspection station comprising at least one ultraviolet illumination source and at least one image capture device and with a second top inspection station comprising at least one visible-spectrum illumination source and at least one image capture device while the food-stuff is supported by at least one of the first conveyor, the second conveyor, and the third conveyor;
wherein the first and second top inspection stations and the first and second bottom inspection stations collectively provide both ultraviolet inspection and visible light inspection of the food-stuff on both top and bottom sides.

33. The method of claim 31, further comprising coordinating operation of the first, second, and third conveyors and synchronizing image capture by the top and bottom inspection stations using a control unit.

34. The method of claim 32, further comprising generating, by the control unit, position and speed information for food-stuff traveling along the travel path using a virtual encoder without requiring a physical shaft encoder.

35. The method of claim 33, wherein generating the position and speed information comprises estimating based at least in part on at least one of: conveyor drive commands, motor current or torque feedback, conveyor motor speed feedback, timing of image frames acquired by the inspection stations, and detection of food-stuff leading and trailing edges by at least one image capture device.

36. The method of claim 33, further comprising triggering image capture by at least one of the top or bottom inspection stations based on position information output by the virtual encoder.

37. The method of claim 33, further comprising adjusting at least one illumination parameter selected from exposure duration, illumination intensity, strobe timing, and spectral channel selection in response to speed information from the virtual encoder.

38. The method of claim 33, further comprising synchronizing image acquisition of the first and second bottom inspection stations with traversal of the food-stuff over the first inter-conveyor gap and the second inter-conveyor gap, respectively, based on position information from the virtual encoder.

39. The method of claim 33, further comprising generating a composite representation of the food-stuff by combining images from at least one top inspection station and at least one bottom inspection station using position and speed information.
